(19) United States
(12) Patent Application Publication
(10) Pub. No.: US 2013/0163810 A1
(43) Pub. Date: Jun. 27, 2013

(54) INFORMATION INQUIRY SYSTEM AND METHOD FOR LOCATING POSITIONS

(71) Applicant: PENG WANG, Shenzhen City (CN)

(72) Inventor: PENG WANG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/572,714

(22) Filed: Aug. 13, 2012

(30) Foreign Application Priority Data
Dec. 24, 2011 (CN) 201110439800.X

(51) Int. Cl. G06K 9/00

(52) U.S. Cl. 382/103

(57) ABSTRACT

An information inquiry system includes an information acquisition unit, to acquire information of a bus route. An image capture unit captures an image of an object on the bus route. An information processing unit compares the object in the image with the information of the bus route to locate the object and access information of the located object. A storage unit stores the information of the object. An output unit displays the information of the bus route as a map and highlights the located object in the map. An information inquiring method is also provided.

### BACKGROUND

1. Technical Field

The present disclosure relates to information inquiry technologies and, particularly, to an information inquiry system and method for locating positions.

2. Description of Related Art

Bus passengers traveling on bus routes for the first time may feel interested in some shops, restaurants, or parks. For various reasons, they may not be able to visit these places in the journey and may wish to visit these places next time. However, as they are not familiar with these sites, locating the positions of these places of interest again could be difficult.

Therefore, it is desirable to provide an information inquiry system and method, which can overcome the above-mentioned shortcomings

### BRIEF DESCRIPTION OF THE DRAWINGS

FIG. 1 is a functional block diagram of an information inquiry system, according to an embodiment.

FIG. 2 is a schematic view showing the operation of the information inquiry system of FIG. 1.

FIG. 3 is a flowchart of an information inquiring method, according to the embodiment.

### DETAILED DESCRIPTION

Embodiments of the disclosure will be described with reference to the accompanying drawings.

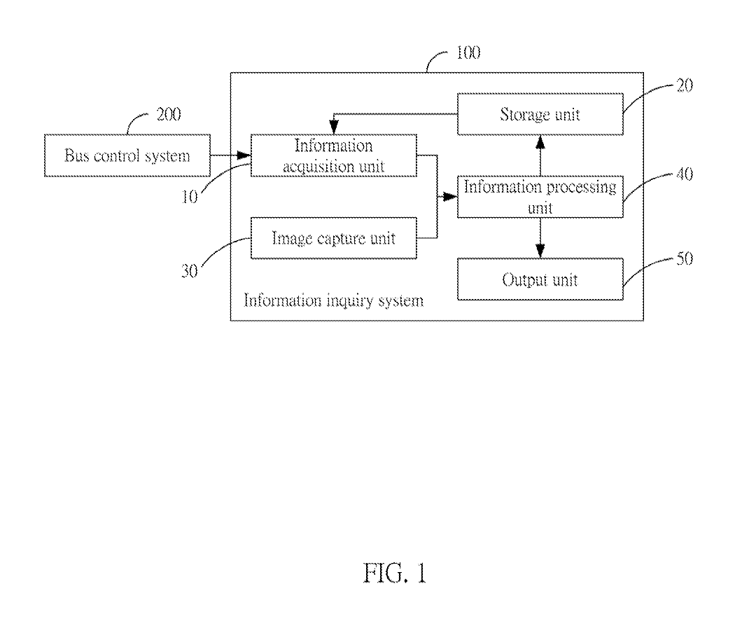

Referring to FIG. 1, an information inquiry system 100, according to an embodiment, can be employed in any portable electronic device (not shown), such as a cell phone and can communicate with a bus control system 200.

The bus control system 200 stores bus map which includes information of each bus route. Information of each bus route includes information of each bus stop and information of buildings or landmarks along the bus route. Information of each bus stop may include a name and a specific position of the bus stop. Information of each building or landmark may include a name, a specific position, and the nearest bus stop.

The bus control system 200 may be installed on every bus. Thus, the information inquiry system 100 can connect with the bus control system 200 directly and establish a path for communication. Alternatively, the bus control system 200 can be remotely positioned and the information inquiry system 100 may communicate with the bus control system 200 via various available networks.

The information inquiry system 100 includes an information acquisition unit 10, a storage unit 20, an image capture unit 30, an information processing unit 40, and an output unit 50.

The information acquisition unit 10 acquires information of a bus route in response to user input. For example, the user input may identify the number of the bus route of current interest, such as Number 12 bus. As such, the information acquisition unit 10 can read the information of such a bus route.

The storage unit 20 stores information of certain bus routes. The information of the certain bus routes may be accessed from the bus control system 200 in advance and stored in the storage unit 20. As such, the information acquisition unit 10 can search the information of a bus route in the storage unit 20 first and can conveniently and quickly access the information of the bus route from the storage unit 20 if the storage unit 20 has previously stored the information of the particular bus route.

If the storage unit 20 has not stored the information of the particular bus route, the information inquiry system 10 connects to the bus control system 200 locally or remotely, and accesses the information of the bus route from the bus control system 200.

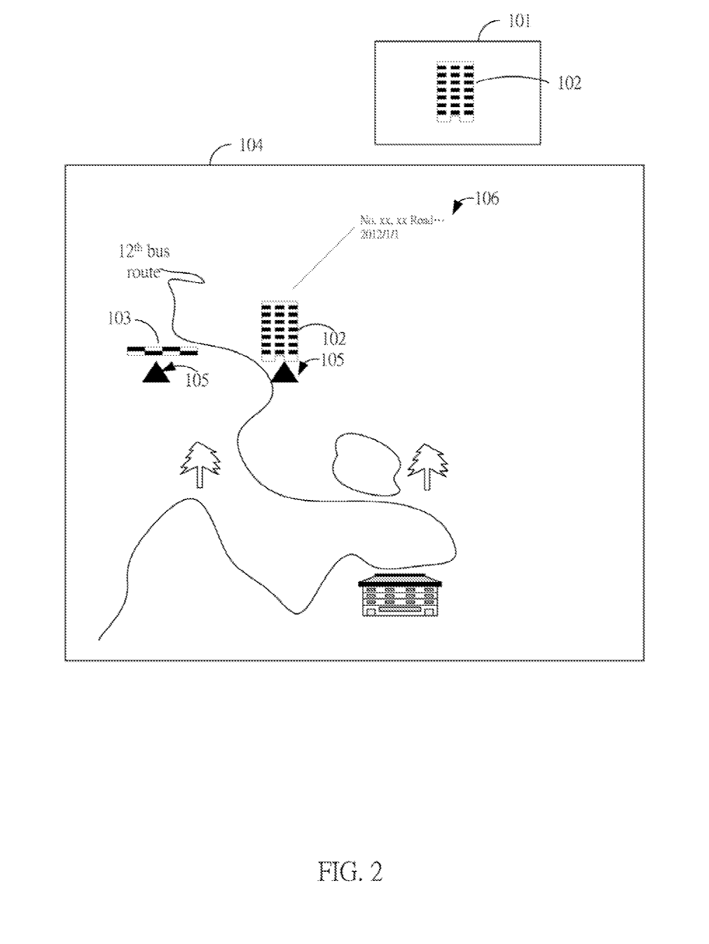

Also referring to FIG. 2, the image capture unit 30, such as a camera module of the portable electronic device, is configured for capturing an image 101 of an object 102, such as a shop, a restaurant, or a park, during a journey on a bus route in response to user operation.

The information processing unit 40 compares the object 102 taken in the image 101 with information of buildings and landmarks contained in the information of each of the bus routes to attempt to locate the object 102 and access information of the object 102, such as the name, the position, and the nearest bus stop 103 of the object 102. The accessed information of the object 102 can be stored in the storage unit 20 as an indexed entry and can be accessed next time, if needed.

The output unit 50, such as a display of the portable electronic device, displays the information of any bus route as a map 104 and highlights the located object 102 in the map 104. For example, the output unit 50 can show marks 105 at the located object 102 and the nearest bus stop 103. The output unit 50 is also configured to display the information of the object 102 as a text remark 106 including an address of the object 102 and the located time.

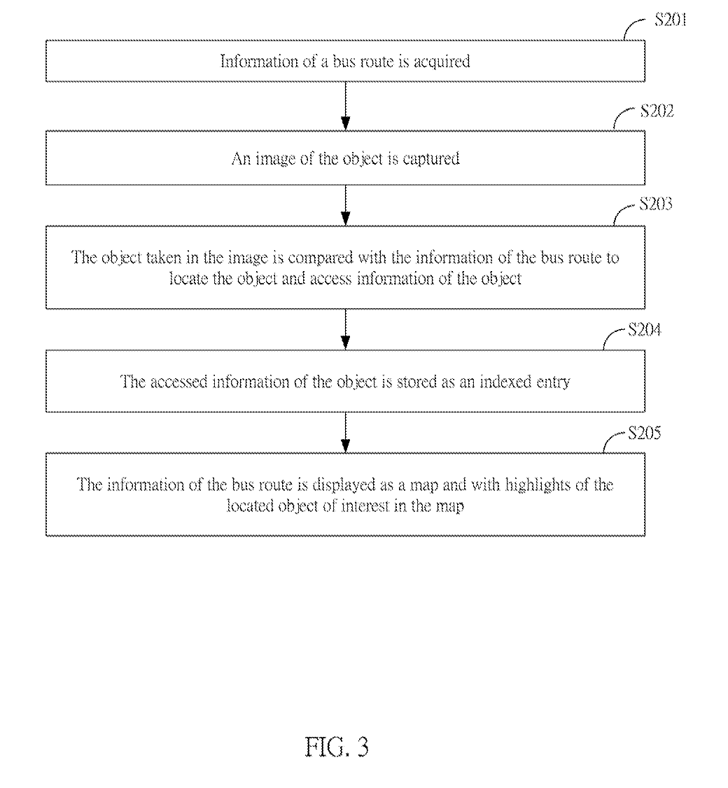

Referring to FIG. 3, an information inquiring method, according to an embodiment, can be implemented on the information inquiry system 100 and includes the following steps.

In step S201, information of a bus route is acquired in response to user input.

In step S202, an image 101 of the object 102 is captured during the journey along the bus route in response to user operations.

In step S203, the object 102 taken in the image 101 is compared with information of buildings and landmarks contained in the information of the bus route to locate the object 102 and access information of the object 102.

In step S204, the accessed information of the object 102 is stored as an indexed entry and can be accessed next time, if needed.

In step S205, the information of the bus route is displayed as a map 104 and with highlights, such as marks 105, of the located object 102 in the map 104, according to the accessed information of the object 102.

Particular embodiments are shown here and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An information inquiry system, comprising:
an information acquisition unit, to acquire information of a bus route;
an image capture unit, to capture an image of an object on the bus route;
an information processing unit, to compare the object in the image with the information of the bus route to locate the object and access information of the located object;
a storage unit, to store the information of the located object; and
an output unit, to display the information of the bus route as a map and highlight the located object in the map.

2. The information inquiry system according to claim 1, wherein the information of the located object comprises name, position, and nearest bus stop of the object.

3. The information inquiry system according to claim 1, wherein the information of the bus route is acquired from a bus control system in advance and stored in the storage unit.

4. The information inquiry system according to claim 3, wherein the information acquisition unit searches for the information of the bus route in the storage unit first and accesses the information of the bus route from the storage unit when the storage unit has stored the information of the bus route.

5. The information inquiry system according to claim 4, wherein when the storage unit has not stored the information of the bus route, the information inquiry system connects to network and accesses information of the bus route from the network.

6. The information inquiry system according to claim 5, wherein the bus control system is installed on each bus, the information inquiry system connects with the bus control system directly and establishes a path for communication.

7. The information inquiry system according to claim 5, wherein the bus control system is remotely positioned and the information inquiry system communicates with the bus control system via various available networks.

8. The information inquiry system according to claim 1, wherein the output unit is configured to display the information of the object as text remarks including an address of the object and the located time.

9. An information inquiring method, comprising:
acquiring information of a bus route;
capturing an image of an object on the bus route;
comparing the object in the image with the information of the bus route to locate the object and access information of the located object;
storing the information of the located object; and
displaying the information of the bus route as a map and highlighting the located object in the map.

10. The method according to claim 9, wherein the information of the located object comprises name, position, and nearest bus stop of the object.

11. The method according to claim 9, wherein the information of the bus route is acquired from a bus control system in advance and stored in a storage unit.

12. The method according to claim 11, further comprising: searching for the information of the bus route in the storage unit first and accessing the information of the bus route from the storage unit when the storage unit has stored the information of the bus route.

13. The method according to claim 12, further comprising: when the storage unit has not stored the information of the bus route, connecting to network and accessing information of the bus route form the network.

14. The method according to claim 9, further comprising: displaying the information of the object as text remarks comprising an address of the object and the located time.
